(19) United States
(12) Patent Application Publication
(10) Pub. No.: US 2026/0290338 A1
(43) Pub. Date: Sep. 24, 2026

(54) Managing Utterance Data Latency

(71) Applicant: Google LLC, Mountain View, CA (US)

(72) Inventor: Sunil Kumar, Cupertino, CA (US)

(21) Appl. No.: 19/473,124

(22) PCT Filed: Apr. 5, 2024
(86) PCT No.: PCT/US2024/023276

§ 371 Date: Oct. 6, 2025

Related U.S. Application Data
(60) Provisional application No. 63/494,891, filed on Apr. 7, 2023.

(51) Int. Cl. G10L 15/22; G10L 15/08; H04R 1/10; H04W 76/14; H04W 88/04

(52) U.S. Cl. CPC G10L 15/22; G10L 15/08; H04R 1/1016; H04W 76/14; G10L 2015/088; H04W 88/04

(57) ABSTRACT

Various embodiments for managing utterance data latency over Bluetooth Low Energy (BLE) are described herein. The techniques described use a CIS connection for communicating an utterance received by an earbud to the audio host (AH). The CIS connection can be used to transmit utterance data (e.g., a hotword followed by a user request) to a computing device to help to improve a user experience by reducing latency in interacting with a virtual assistant or perform some other operation.

### CROSS REFERENCES TO RELATED APPLICATIONS

This Application claims priority to U.S. Provisional Patent Application No. 63/494,891, entitled “Managing Hotword Latency,” filed on Apr. 7, 2023, the entire disclosure of which is hereby incorporated by reference for all purposes.

### BACKGROUND

Bluetooth technologies, such as Bluetooth basic rate or extended data rate (BR/EDR, which can also be referred to as “Bluetooth classic”) and Bluetooth Low Energy (BLE) communications can be used by a wide variety of devices. In some cases, Bluetooth technologies can be used to support different type of “audio use cases” such as telephony (cellular), Voice-Over-IP (VOIP) calls, voice calls, virtual assistant interaction, and media playback (e.g., music, game notifications, . . . ). These audio use cases use a Connected Isochronous Stream (CIS) connection that have reserved bandwidth for audio streams and an Asynchronous Connection Oriented Link (ACL) for control data that is asynchronous in nature. In some cases, however, the user may experience a degraded user experience when using Bluetooth technologies.

### SUMMARY

Various embodiments for managing utterance data latency over Bluetooth Low Energy (BLE) are described herein. The techniques described using a CIS connection for communicating an utterance received by an earbud to the audio host (AH). Prior to techniques described herein, an ACL connection would be used to transmit an utterance since a user utterance is asynchronous in nature. According to some examples, user utterance data includes a “hotword” that is used to wake a virtual assistant followed by a request that a user would like to be performed by the virtual assistant. In some cases, a user may have Bluetooth devices (e.g., earbuds) simultaneously connected with more than one device (e.g., a phone, a tablet, a personal computer, . . . ). Each of these devices can be engaged in different activities (e.g., music playback, Wi-Fi, multipoint connections, . . . ) that may cause a delay when attempting to interact with a virtual assistant. Using techniques described herein, a CIS connection can be used to transmit utterance data (e.g., a hotword followed by a user request) to a computing device to help to improve a user experience by reducing latency in interacting with a virtual assistant, or perform some other operation.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for managing utterance latency over Bluetooth Low Energy. The method also includes establishing an asynchronous connection-less (ACL) connection between an earbud and a computing device. The method also includes establishing a connected isochronous stream (CIS) connection between an earbud and the computing device. The method also includes detecting, at the earbud, an utterance. The method also includes transmitting, using the CIS connection, the utterance to the computing device. The method also includes receiving, using the CIS connection, audio data. Other embodiments of this aspect include corresponding computer systems, apparatus, and computer programs recorded on one or more computer storage devices, each configured to perform the actions of the methods.

Implementations may include one or more of the following features. The method may include establishing a second CIS connection between the earbud and the computing device, where the second CIS connection is used for audio traffic. Detecting the utterance may include determining a likelihood that the utterance includes a hotword. The method may include determining to transmit the utterance to the computing device based, at least in part, on the determining the likelihood that the utterance includes the hotword. The utterance may include a hotword and a user request for a virtual assistant. The relay link is used to transfer data between the earbud and the second earbud. The earbud and a second earbud are true wireless stereo earbuds. In some examples, a flush timeout value associated with the CIS connection for hotword transfer is set to a large flush value (e.g., 150, 200, . . . ). The flush timeout value for other CIS connections can be different (e.g., for music playback, . . . ). Implementations of the described techniques may include hardware, a method or process, or computer software on a computer-accessible medium.

One general aspect includes a wireless earbud system that uses a Bluetooth Low Energy (BLE) audio protocol. In some examples, the wireless earbud system also includes a first earbud may include: a first wireless interface, a first speaker, a first processing system, and a first microphone. In some examples, the system also includes a second earbud may include: a second wireless interface, a second speaker, a second processing system, and a second microphone, where one of the first earbud or the second earbud is configured to: establish a connected isochronous stream (CIS) connection with a computing device. In some examples, the system also includes obtaining microphone data; and transmitting the microphone data using the CIS connection. Other embodiments of this aspect include corresponding computer systems, apparatus, and computer programs recorded on one or more computer storage devices, each configured to perform the actions of the methods.

Implementations may include one or more of the following features. The wireless earbud system where the one of the first earbud or the second earbud is further configured to establish a second CIS connection with the computing device, where the second CIS connection is used for audio traffic. In some examples, the one of the first earbud or the second earbud is further configured to determine a likelihood that the microphone data includes a hotword. The wireless earbud system may include determining to transmit the microphone data to the computing device based, at least in part, on the determining the likelihood that the microphone data includes the hotword. The microphone data may include a hotword and a user request for a virtual assistant. The one or more of the first earbud or the second earbud is further configured to establish a relay link connection between the first earbud and a second earbud, where the relay link is used to transfer data between the first earbud and the second earbud. The first earbud and a second earbud are true wireless stereo earbuds. A flush timeout value associated with the CIS connection is set to a larger timeout value as compared to music playback, and the like. Implementations of the described techniques may include hardware, a method or process, or computer software on a computer-accessible medium.

One general aspect includes a non-transitory computer-readable medium containing computer executable instructions that establish an asynchronous connection-less (ACL) connection between an earbud and a computing device. In some examples, the instructions also include establishing a connected isochronous stream (CIS) connection between an earbud and the computing device. In some examples, the instructions also include detecting, at the earbud, an utterance. The instructions also include transmitting, using the CIS connection, the utterance to the computing device. In some examples, the instructions also include receiving, using the CIS connection, audio data. Other embodiments of this aspect include corresponding computer systems, apparatus, and computer programs recorded on one or more computer storage devices, each configured to perform the actions of the methods.

Implementations may include one or more of the following features. The non-transitory computer-readable medium where detecting the utterance may include determining a likelihood that the utterance includes a hotword. The computer executable instructions that, when executed by a processor, further cause the processor to determine a likelihood that the utterance includes a hotword. The non-transitory computer-readable medium may include determining to transmit the utterance to the computing device based, at least in part, on the determining the likelihood that the utterance includes the hotword. Implementations of the described techniques may include hardware, a method or process, or computer software on a computer-accessible medium.

### BRIEF DESCRIPTION OF THE DRAWINGS

FIG. 1 illustrates a system in which data is transmitted between earbuds and computing device.

FIG. 2 shows an example of the available bandwidth for an BLE ACL connection during a music playback use case.

FIG. 3 shows a table that illustrates the throughput assuming different values for the average number of frames allocated to the LE ACL connection.

FIG. 4 shows an example of transmissions in an ACL connection that is experiencing a poor link condition.

FIG. 5 illustrates using an LE CIS connection to transfer user utterance data.

FIG. 6 illustrates that the performance of the CIS connection in poor link conditions is much better than the ACL performance.

FIG. 7 illustrates a method that may be performed for using a CIS connection to communicate user utterance data to an audio host.

FIG. 8 illustrates an embodiment of a method for obtaining an utterance at an earbud and transmitting the utterance to the audio host.

### DETAILED DESCRIPTION

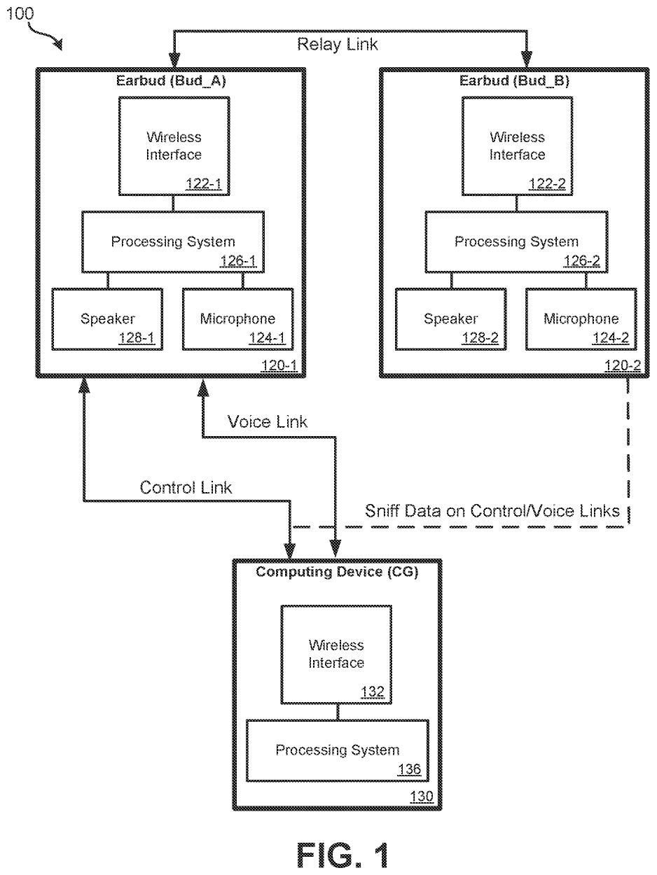

FIG. 1 illustrates a system 100 in which data is transmitted between earbuds 120, and computing device 130. Downstream audio is transmitted from computing device 130 to earbuds 120 and upstream audio (e.g., voice captured via microphone) is transmitted from one of earbuds 120 to computing device 130. System 100 includes: earbud 120-1 (e.g., a right or left earbud of a pair of true wireless earbuds); earbud 120-2 (e.g., a true wireless earbud for the opposite ear from earbud 120-1); and computing device 130. The computing device 130 and the earbuds 120 are configured to support telephony (cellular) and Voice-Over-IP (VOIP) call use cases using a wireless technology, such as but not limited to Bluetooth Classic (BR/EDR) technology and Bluetooth Low Energy (BLE) technology. As illustrated in FIG. 1, the computing device 130 is configured to perform the Call Gateway (CG) role and the earbuds 120 are configured to perform the Call Terminal (CT) roles.

Earbuds 120 can be true wireless earbuds, which refer to a pair of earbuds that do not have any physical connection, such as a wire or band, connecting the two earbuds or with an audio source. True wireless earbuds can allow a user to use both earbuds 120 or use a single earbud (either earbud 120-1 or earbud 120-2) at a given time.

Some components of earbuds 120 are illustrated. Specifically, earbuds 120 include: wireless interfaces 122; microphones 124; processing systems 126; and speakers 128. All components of earbuds 120 can be housed by housings of the respective earbud, which can be made from a rigid or semi-rigid material. Earbuds 120 can be shaped to be at least partially inserted into a user's ear so that it will stay in place during normal body movements.

Wireless interface 122 can be a short-range wireless interface that allows for a device-to-device exchange of data. For example, short-range refers to a distance of up to 1, 10, 15, or 20 meters. Wireless interface 122 can be a Bluetooth interface that allows for data to be exchanged according to a communication protocol from the Bluetooth family of communication protocols, such as Bluetooth basic rate or extended data rate (BR/EDR, which can also be referred to as “Bluetooth classic”), BLE, and/or Bluetooth LE audio. Wireless interface 122 can communicate using the 2.4 GHz band, which for Bluetooth spans from 2.4 GHz to 2.4835 GHz. This frequency band can be divided up into a number of channels, such as 80 channels for Bluetooth BDR/EDR, each 1 MHz wide, or 40 channels for Bluetooth LE or LE Audio, which are each 2 MHz wide. Bluetooth communications can involve frequent channel changes within the 2.4 GHz band, such as up to 1600 channel changes per second.

Wireless interfaces 122 can be understood as Bluetooth wireless interfaces in that each of wireless interfaces 122 can communicate with other Bluetooth interfaces (e.g., wireless interface 132) that conform to the Bluetooth standard. For example, in FIG. 1, audio source 130 has a Bluetooth interface, referred to as wireless interface 132. Wireless interfaces 122 can exchange data using Bluetooth LE with wireless interface 132. For example, wireless interface 132 may be used to transmit downstream audio packets to wireless interfaces 122 while upstream audio packets constructed using audio captured using one or more of microphones 124 are transmitted by wireless interfaces 122 to wireless interface 132.

In earbud 120-1, processing system 126-1 can be in communication with wireless interface 122-1; speaker 128-1; and microphone 124-1. In earbud 120-2, processing system 126-2 can be in communication with wireless interface 122-2; speaker 128-2; and microphone 124-2. Processing systems 126 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as flash memory or other forms of memory.

Speakers 128 are used for outputting audio to a user. Processing system 126 can control the volume of audio received via wireless interfaces 122. Microphones 124 are present in each of earbuds 120. Microphones 124 can be used to capture audio in the vicinity of earbuds 120, such as speech of a user wearing at least one of earbuds 120 and transmit the captured audio as upstream audio packets via Bluetooth (e.g., Bluetooth LE Audio) to computing device 130. Microphones 124 can also be used to capture audio to perform noise cancellation.

A particular earbud of earbuds 120 may be designated as a “primary” earbud (PE) and the other earbud is designated as a second earbud (SE). In some examples, both the PE and the SE establish a control link and voice link with the computing device 130. In other examples, the PE, such as earbud 120-1 establishes a control link and a voice link with the computing device 130 while the SE, such as earbud 120-2, passively sniffs the voice link and the control link (as illustrated by the dashed line) between the PE and the computing device 130. In some examples, one or more of the earbuds 120 may establish more than one CIS and/or ACL links with an audio host, such as computing device 130.

A single earbud, or two or more earbuds, may capture and stream upstream audio to computing device 130. Earbuds 120 may decide among themselves which earbud is to transmit upstream audio. For instance, the decision as to which earbud is to transmit upstream audio may be based on battery charge in each earbud, signal strength between each earbud and computing device 130, and/or an amount of noise detected by each earbud on captured audio. In some embodiments, the audio captured by each of microphones 124 is combined together to create an upstream audio stream that is transmitted to computing device 130.

An earbud manufacturer is not in control of the fundamental experience. Earbud manufacturers rely on the source's selection of microphone channel rather than the earbud's (and thus earbud manufacturer's) selection. Some phone manufacturers may decide to combine the microphone audio from both earbuds; others may choose to use only the left; yet others may choose the opposite; and others may choose to switch periodically based upon some algorithm that the earbud manufacturer had no way to determine.

In a first arrangement, a left (“L”) earbud and a right (“R”) earbud decide between themselves which one will be the PE and which earbud will be the SE. In both arrangements, one earbud can optionally sniff data sent/received by the other earbud. Sniffing is defined as capturing the data wirelessly transmitted that is intended for a device other than the one doing the sniffing. Combining the microphone data sent by another earbud with a given earbud's microphone can be useful for a multitude of purposes, amongst which are beamforming of sound capture, wind/ambient noise reduction, increasing SNR of sound capture, finding direction of an auditory stimulus around the user, etc. The arrangements detailed herein can also be applied to loudspeakers.

Computing device 130 includes wireless interface 132 and processing system 136. Examples of computing device 130 can include: a smartphone; a desktop, laptop, or tablet computer; a gaming device; a smart television; a digital music player device; a smartwatch; smart glasses; an augmented reality or a virtual reality headset; or any other device from which a user may desire to stream audio to earbuds 120 and, possibly, transmit upstream audio from earbuds 120 to computing device 130. Computing device 130 includes wireless interface 132, which can communicate with earbuds 120, and other devices, such as HID device 140, using device-to-device communication protocols, such as a Bluetooth communication protocol (e.g., Bluetooth classic, Bluetooth LE, or Bluetooth LE Audio). Therefore, computing device 130 can transmit a downstream audio stream to one or more of earbuds 120 via wireless interface 132, receive an upstream audio stream from one or more of earbuds 120, and also communicate with one or more other Bluetooth devices.

Processing system 136 may include one or more special-purpose or general-purpose processors. Such special-purpose processors may include processors that are specifically designed to perform the functions of the components detailed herein, such as detailed in relation to processing systems 126.

The earbuds 120 may be configured to support telephony (cellular) voice call, Voice-Over-IP (VOIP) call, and media playback (music, game, notifications, etc.) use cases using both Bluetooth classic and BLE technologies. When using Bluetooth classic, the voice link uses an eSCO connection and the control link uses an ACL connection. When using BLE, the voice link uses a CIS connection, and the control link uses an ACL connection.

The eSCO connection associated with Bluetooth and the CIS connection associated with BLE both reserve bandwidth per the use case Quality of Service (QoS) requirements at the connection setup time. This reserved bandwidth is static and does not change for the lifetime of the connection. The actual utilized bandwidth, however, depends on the prevalent link conditions (environment, range, etc.). Therefore, the utilized bandwidth may change throughout the lifetime of the connection. For example, it is possible that 100% of the reserved bandwidth is used at some times, while at other times, some other percentage (e.g., 10%, 20%, 50%, . . . ) of the reserved bandwidth is used at other times.

As illustrated in FIG. 1, the earbuds 120 are configured to use a relay link to transfer data between themselves. In some examples, the relay link can be used to forward one or more voice/audio packets from one earbud to another earbud to another earbud. For instance, in the case when one earbud does not receive a packet, the relay link can be used to forward the packet from the earbud that received the packet to the earbud that did not receive the packet from the computing device. In contrast to the voice link that has a reserved bandwidth, the relay link does not have reserved bandwidth. Instead, the utilized bandwidth for the relay link depends on two factors including if the voice/audio packet needs to be forwarded, and the prevalent link conditions (environment, person's body absorption of radio waves, etc.). Generally, if the link conditions are good then there may not be any need to retransmit a packet, but if the link conditions are poor then a packet may need to be retransmitted.

Accordingly, the reserved and utilized bandwidth for the audio use cases is a function of the reserved and utilized bandwidth of the eSCO or CIS connection used for the voice and the utilized bandwidth of the relay link. As the earbud may perform other activities (for example, scans to connect to other devices, multipoint connection to maintain connection with other devices, Virtual assistant, etc.) concurrently with the audio use cases, optimization of the bandwidth usage of the audio use cases can improve the performance and user experience for the audio and concurrently running activities.

Using techniques described herein, some data that is asynchronous in nature, such as user utterance data can be transferred using a CIS connection instead of using an ACL connection to transfer the utterance data. As will be described in more detail below, the user utterance data may be an utterance that is used to interact with a virtual assistant (e.g., a hotword followed by a request). Prior to techniques described herein, a BLE ACL connection would be considered the choice for communicating an utterance (e.g., a hotword/request) from an earbud to a computing device since an utterance is asynchronous in nature. Transmitting an utterance using an ACL link, however, may result in an unsatisfactory user experience. On the other hand, even though the LE CIS connection is defined for audio streams' (isochronous traffic) traffic, using techniques described herein, a CIS connection that meets low latency specifications can be used for transferring asynchronous data, such as an utterance that includes a hotword.

A “hotword” that may also be referred to as a trigger word, wake-up word, or wake word refers to a word or phrase that when detected activates software/hardware associated with a virtual assistant. For example, a user may utter a hotword (e.g., “OK Virtual Assistant . . . ”, . . . ) to activate a virtual assistant and request the virtual assistant to perform one or more actions (e.g., play music, answer a question, . . . ). In some configurations, an utterance that includes the hotword is transmitted from an earbud to the audio host (e.g., a phone, tablet, . . . ) using a CIS connection between an earbud and a computing device. According to some examples, response data by the virtual assistant can be sent to an earbud using a CIS connection that also transfers music data and/or other voice data. Using a CIS connection, instead of the ACL connection, helps to provide a better user experience by reducing latency.

As an example, when using earbuds that use BLE technology, the use of a CIS connection to transfer utterances can improve the interaction between a user and a virtual assistant by reducing the latency when communicating with the virtual assistant. The use of the CIS connection also helps to improve the user experience of other operations that may be performed by the earbuds (e.g., scans, multipoint, music playback, Wi-Fi in 2.4 GHz band, . . . ). As an example, a user might have their earbuds simultaneously connected with different devices (e.g., a phone, tablet, personal computer, . . . ) and engaged in different activities (e.g., music playback and voice assistant). By transferring utterances using a CIS connection helps to ensure that the user does not experience unacceptable lag that can result in a poor user experience. In addition/alternatively to using the CIS link to transfer an utterance that includes a hotword, the CIS connections can also be applied to other data that would benefit from a transfer of data (e.g., data that is considered asynchronous in nature) using a high throughput and low latency CIS connection over LE as opposed to using an ACL connection.

As briefly discussed above, BLE supports two types of connections for point to point (unicast) communications including an ACL connection that is generally used for carrying the wireless link control traffic (e.g., increase/decrease TX power), application control traffic (e.g., play/pause music playback), other user data such as utterances, and application asynchronous data traffic (e.g., keyboard key presses/releases, mouse movements) and CIS connections that are used for carrying the audio streams traffic (e.g. compressed audio packets for a voice call, music playback, virtual assistant responses, . . . ).

As discussed, an utterance that includes a hotword is considered asynchronous in nature since it is unknown when a user will utter a hotword. Using an ACL connection, however, can result in a poor user experience when interacting with a virtual assistant. An ACL connection is a periodic connection that does not provide reserved/guaranteed bandwidth. As such, the amount of data transferred in every period may vary and depends on the bandwidth that the devices could allocate to the ACL connection during that period. The amount of bandwidth allocated to the LE ACL connection also depends on other ongoing activities (e.g., music playback, LE Scans, Wi-Fi in 2.4 GHz band, . . . ). A CIS connection, on the other hand, provides a low latency, high throughput connection that can be used to meet the low latency specifications of interacting with a virtual assistant.

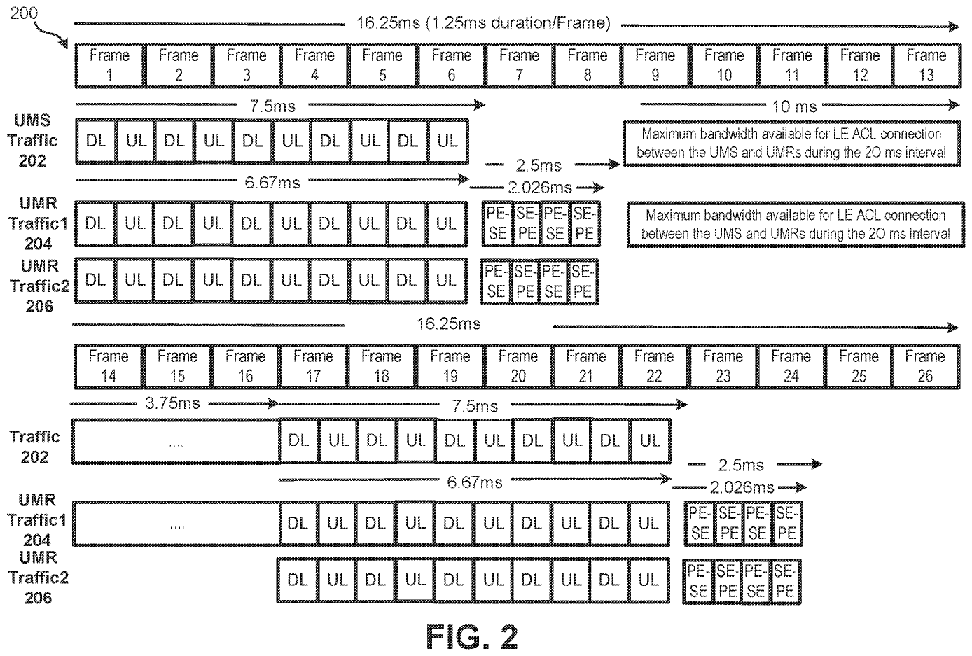

FIG. 2 shows an example 200 of the available bandwidth for an LE ACL connection during a music playback use case. As illustrated, Unicast Media Sender (UMS) traffic 202 is transmitted from an audio source, such as computing device 130 (e.g., a mobile phone, a tablet, a personal computer, . . . ) and the Unicast Media Receiver (UMR) traffic 204 is received by one or more devices, such as one or more of the earbuds 120 described above with reference to FIG. 1.

For explanatory purposes, the BLE CIS connections and the BLE ACL connections use a 20 ms connection interval. As FIG. 2 shows, the maximum bandwidth that is possibly available for the ACL connection between UMS (e.g., computing device 130) and the UMR (e.g., an earbud) is 8 frames (50% of the available frames in the 20 ms duration). This available bandwidth, however, is not reserved or guaranteed for a specific ACL connection.

The available bandwidth is not guaranteed to a particular ACL connection since there may be other ongoing activities that may use some of the bandwidth, such as LE Scans, Wi-Fi in 2.4 GHz band, phone connections to other devices (e.g., a watch), earbud connections to other devices, and the like. As such, the number of frames used for the LE ACL connections could vary from 1 frame to 8 frames across the intervals. In some cases, using an LE ACL to communicate virtual assistant utterances and/or responses may result in a poor user experience.

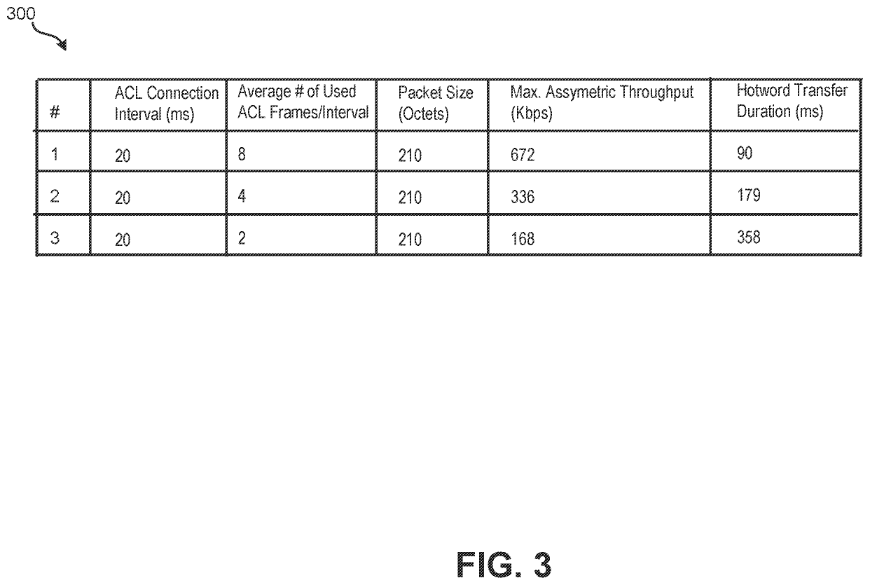

FIG. 3 shows a table 300 that illustrates the throughput assuming different values for the average number of frames allocated to the LE ACL connection in a 20 ms interval and the lowest hotword latency possible with that maximum throughput. For purposes of explanation, the hotword size used for the calculations is 7500 bytes. Other hotword sizes, however, may be used.

Referring to FIG. 3, when 8 frames are available for the ACL connection, the hotword transfer duration is 90 ms with a throughput of 672 Kbps. When 4 of the 8 frames are available for the ACL connection, the transfer duration increases to 179 ms with a throughput of 336 Kbps. Finally, when 1 of the 8 available frames is available for transfer of the hotword over an ACL connection, the duration increases to 358 ms and the throughput drops to 168 Kbps. In addition to the duration of the hotword transfer time, the hotword transfer latency also includes system delays. This results in a hotword transfer latency that is higher than the hotword transfer duration illustrated in FIG. 3. As discussed above, an increase in the hotword transfer latency can result in an unacceptable user experience.

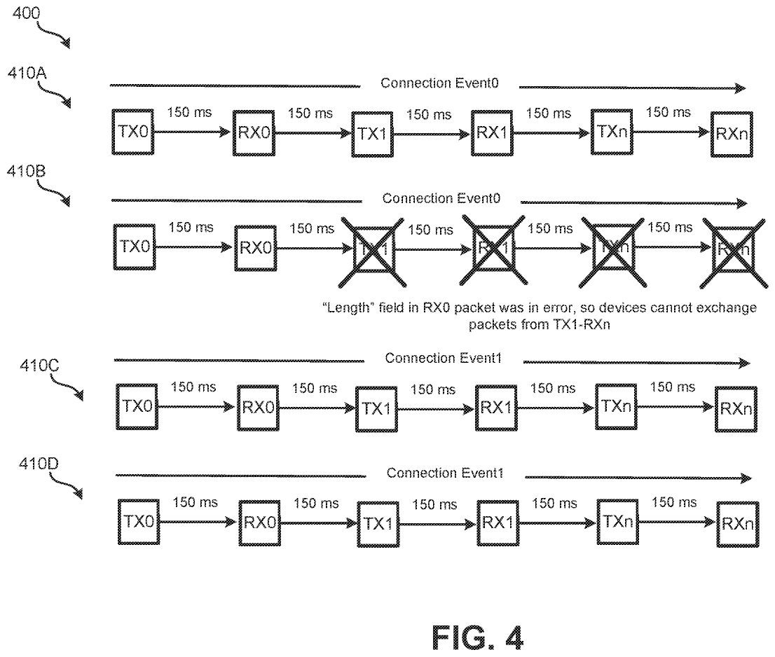

FIG. 4 shows an example of transmissions in an ACL connection that is experiencing a poor link condition. In addition to the hotword transfer duration illustrated in FIG. 3, the hotword transfer duration using an LE ACL connection can become worse in poor link conditions (e.g., interference due to Wi-Fi or some other interference/condition). As illustrated, the consecutive transmissions in each ACL connection event are separated by a fixed duration (150 us) that is measured from the end of the latest packet. In order to successfully communicate with a device using an ACL connection, the receiving device must be able to know the end of the latest packet accurately so that the receiving device can determine the time the next transmission is to be started in order to successfully continue the communication. In some examples, the receiving device identifies the end of the latest packet by using the “Length” field in the “Payload Header” of the received packet.

In the current example illustrated in Connection Event0 410, the connection event0 for the receiving device 410B is not able to identify the start of the third transmission (as indicated by the X). For instance, the second received packet may be corrupted due to poor link conditions and the “Length” field of that packet may be in error. As such, the receiving device is not able to accurately identify the end of the latest received packet and the communication in the Connection Event0 is not able to continue. The communication on the ACL in this case will resume in the next connection event, such as Connection Event1 410C, as the successive connection events are separated from each other by the fixed duration (connection interval). As FIG. 4 shows, the TX1 to RXn packets are not transmitted in the poor link case, dropping the throughput and increasing the hotword latency.

As can be seen by referring to FIGS. 2, 3, and 4, the LE ACL is a periodic connection that doesn't provide reserved/guaranteed bandwidth. Additionally, as illustrated in FIG. 4, the LE ACL connection throughput may significantly degrade in poor link conditions as a large portion of bandwidth available in a particular connection event may go unused. This can result in hotword transfer duration that can vary significantly, and in some cases fail to meet a hotword latency specification.

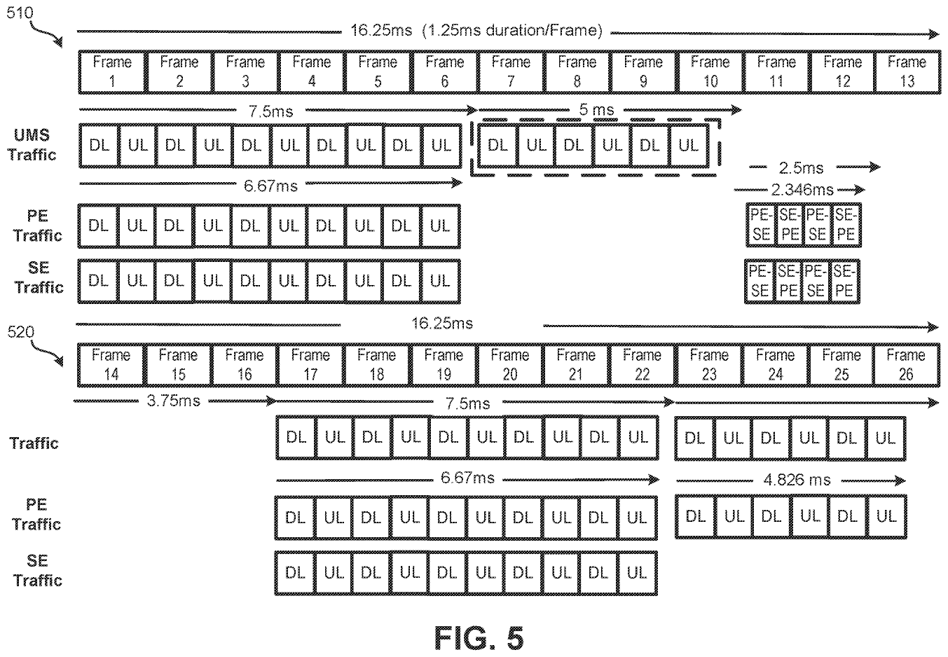

FIG. 5 illustrates using an LE CIS connection to transfer user utterance data. To help provide a better user experience and help ensure that a hotword latency specification is satisfied, the utterance that includes the hotword is transmitted (e.g., from an earbud 120 to a computing device 130) using an LE CIS connection. As discussed above, the LE CIS connection is a periodic connection that provides reserved/guaranteed bandwidth. Additionally, CIS connection events are divided into sub-events wherein successive sub-events are separated from each other by a fixed duration (Sub_Interval) and hence, the start time of the next subevent does not depend on the packets exchanged in the current sub-event. As such, the duration to transfer an utterance that includes a hotword is more deterministic as compared to using an LE ACL connection.

As illustrated in FIG. 5, the diagram depicts two intervals (interval 510 and 520) using a CIS connection for music playback and a second CIS connection (illustrated within the dashed line from frames 7-10) for utterance data transfer. For purposes of explanation, the Flush Timeout (FT) for the second CIS is set to the maximum possible value (e.g., 255). In other examples, the FT may be set to other values (e.g., 125, 150, 175, 200, 225, . . . ) A high/large value of the FT helps to ensure that there will be a large number (e.g., 762) of retransmissions before the utterance packets may be flushed/dropped by the earbud. In the example illustrated in FIG. 5, this means that there will be up to about five seconds duration elapsed before the utterance packets may be dropped. This is a very large duration considering the hotword latency specifications are typically in hundreds of milliseconds and hence, practically provides reliable transport for the use case.

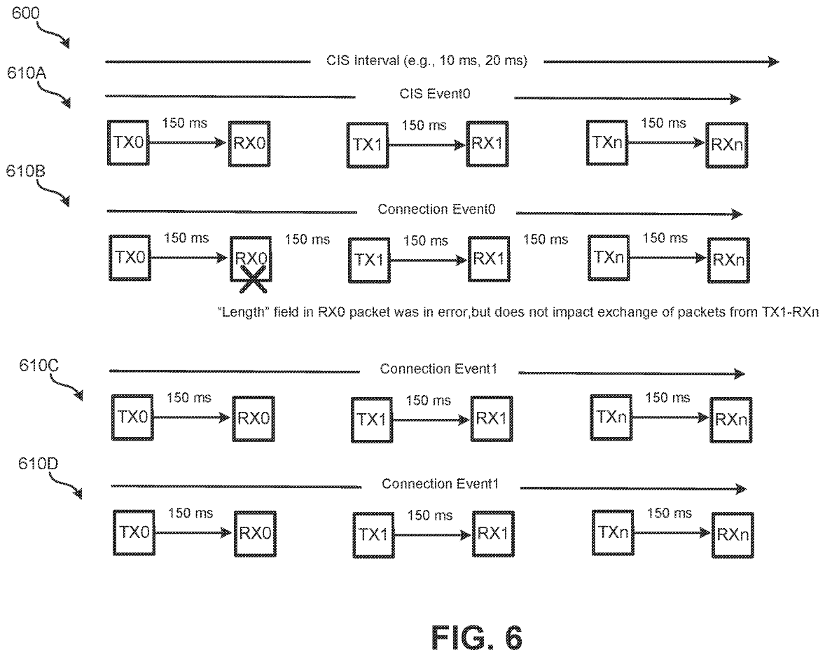

FIG. 6 illustrates that the performance of the CIS connection in poor link conditions is much better than the ACL performance in poor link conditions. As shown in FIG. 6, even though the “Length” field in the RX0 packet was in error (as indicated by the X) in the connection event0 610B for the receiving device, this error does not impact the transmissions in following sub-events in the same CIS event 610A and hence, the hotword throughput and latency impact is minimized.

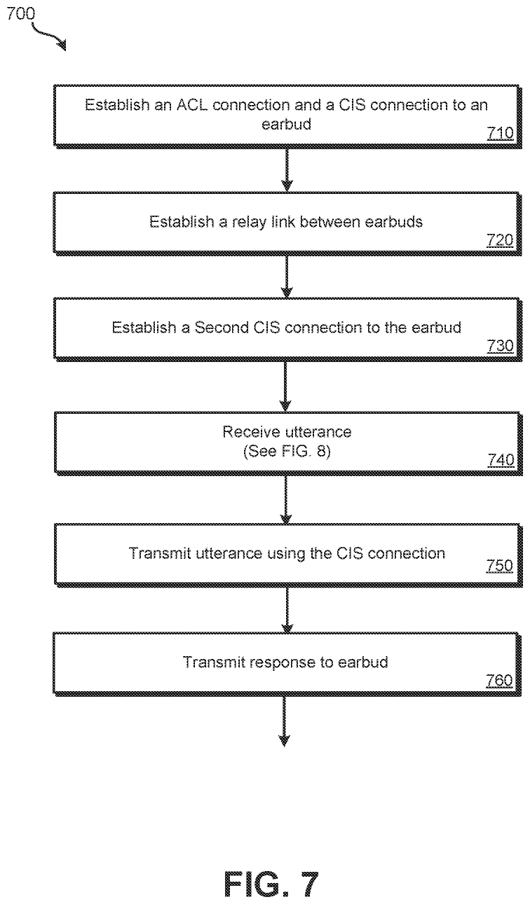

Various methods may be performed using the systems, states, and arrangements detailed in relation to FIGS. 1-6. FIG. 7 illustrates a method that may be performed for using a CIS connection to communicate virtual assistant traffic to an audio host. At block 710, an earbud, such as earbud 120-1 can establish an ACL connection and a CIS connection with an audio host, such as computing device 130. In some examples, the second earbud, such as earbud 120-2 does not establish an ACL connection or a CIS connection with the computing device 130, which is unaware of earbud 120-2.

At block 720, a relay link is established between the first earbud, such as earbud 120-1, and the second earbud, such as earbud 120-2. As discussed above, the relay link can be used to transfer data between a first earbud (PE), such as earbud 120-1, and the SE, such as earbud 120-2.

At block 730, a second CIS connection can be established between the earbud and the audio host, such as computing device 130. As discussed above, the second CIS connection can be used to transmit utterance data to the audio host, such as the computing device 130.

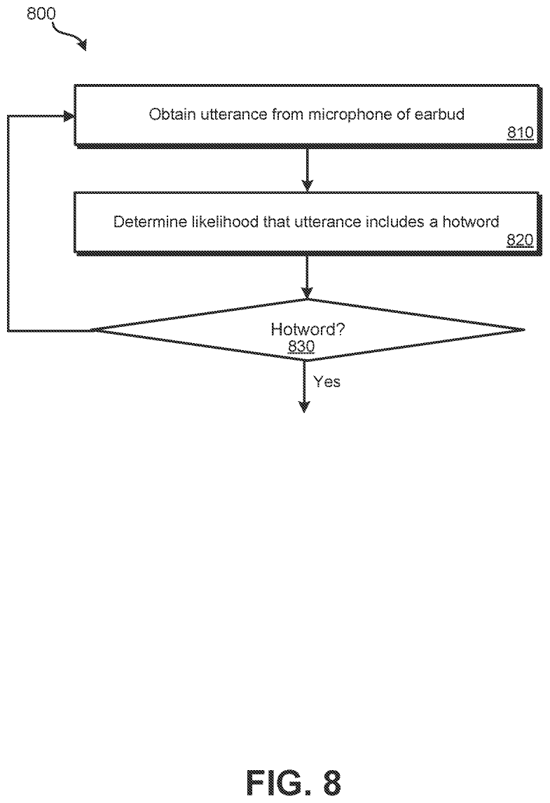

At block 740, an utterance is received at the earbud. As discussed above, the utterance may include a hotword and a request that is used to interact with a virtual assistant. See FIG. 8 for more details.

At block 750, the utterance is transmitted to the audio host using the second CIS connection. As discussed above, the utterance may include both a hotword and a request for the virtual assistant.

At 760, a response may be transmitted over the first CIS connection (e.g., along with the music) to an earbud 120. As discussed above, the response may be from the virtual assistant and may be included with any audio data being transmitted to the earbud.

FIG. 8 illustrates an embodiment of a method 800 for obtaining an utterance at an earbud and transmitting the utterance to the audio host. Either a left or right earbud can be configured to obtain the utterance and/or transmit the utterance.

At block 810, microphone data is obtained from an earbud. As discussed above, microphone data can be obtained from microphone 124-1 for earbud 120-1, which in this example has CIS connections established with the AH. In other examples, the microphone data can be obtained from microphone 124-2 for earbud 120-2, which in this example does not have a CIS connection established with the AH. The earbud 120-2 may then use the relay link to transfer the utterance to the earbud 120-1 for transmission.

At block 820, a determination is made as to whether the utterance includes a hotword. In some examples an earbud 120 can be configured to perform processing to determine a likelihood that the utterance includes a hotword associated with a virtual assistant. According to some configurations, the earbud 120 performs limited processing (e.g., due to limited processing resources) to identify whether or not the utterance includes a hotword. In some cases, an earbud may determine that an utterance is likely to include a hotword, when it actually does not.

At block 830, a determination is made as to whether a hotword is included within the utterance. When the hotword is likely to be included within the utterance, the process moves to block 840. When there is not a hotword, the process returns to 810.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for managing utterance latency over Bluetooth Low Energy, the method comprising:
establishing an Asynchronous Connection Oriented Link (ACL) connection between an earbud and a computing device;
establishing a Connected Isochronous Stream (CIS) connection between an earbud and the computing device;
detecting, at the earbud, an utterance;
transmitting, using the CIS connection, the utterance to the computing device; and
receiving, using the CIS connection, audio data associated with the utterance.

2. The method of claim 1, further comprising establishing a second CIS connection between the earbud and the computing device, wherein the second CIS connection is used for audio traffic.

3. The method of claim 1, wherein detecting the utterance comprises determining a likelihood that the utterance includes a hotword.

4. The method of claim 3, further comprising determining to transmit the utterance to the computing device based, at least in part, on the determining the likelihood that the utterance includes the hotword.

5. The method of claim 1, wherein the utterance comprises a hotword and a user request for a virtual assistant.

6. The method of claim 1, further comprising establishing a relay link connection between the earbud and a second earbud, wherein the relay link is used to transfer data between the earbud and the second earbud.

7. The method of claim 1, wherein the earbud and a second earbud are true wireless stereo earbuds.

8. The method of claim 1, wherein a flush timeout value associated with the CIS connection is set to at least 150.

9. A wireless earbud system that uses a Bluetooth Low Energy (BLE) Audio protocol, comprising:
a first earbud comprising: a first wireless interface, a first speaker, a first processing system, and a first microphone; and
a second earbud comprising: a second wireless interface, a second speaker, a second processing system, and a second microphone, wherein one of the first earbud or the second earbud is configured to:
establish a Connected Isochronous Stream (CIS) connection with a computing device;
obtain microphone data; and
transmit the microphone data using the CIS connection.

10. The wireless earbud system of claim 9, wherein the one of the first earbud or the second earbud is further configured to establish a second CIS connection with the computing device, wherein the second CIS connection is used for audio traffic.

11. The wireless earbud system of claim 9, wherein the one of the first earbud or the second earbud is further configured to determine a likelihood that the microphone data includes a hotword.

12. The wireless earbud system of claim 11, further comprising determining to transmit the microphone data to the computing device based, at least in part, on the determining the likelihood that the microphone data includes the hotword.

13. The wireless earbud system of claim 9, wherein the microphone data comprises a hotword and a user request for a virtual assistant.

14. The wireless earbud system of claim 9, wherein the one or more of the first earbud or the second earbud is further configured to establish a relay link connection between the first earbud and a second earbud, wherein the relay link is used to transfer data between the first earbud and the second earbud.

15. The wireless earbud system of claim 9, wherein the first earbud and a second earbud are true wireless stereo earbuds.

16. The wireless earbud system of claim 9, wherein a flush timeout value associated with the CIS connection is set to at least 150.

17. A non-transitory computer-readable medium containing computer executable instructions that, when executed by a processor, cause the processor to perform a method, comprising:
establishing an Asynchronous Connection Oriented Link (ACL) connection between an earbud and a computing device;
establishing a Connected Isochronous Stream (CIS) connection between an earbud and the computing device;
detecting, at the earbud, an utterance;
transmitting, using the CIS connection, the utterance to the computing device; and
receiving, using the CIS connection, audio data.

18. The non-transitory computer-readable medium of claim 17, wherein detecting the utterance comprises determining a likelihood that the utterance includes a hotword.

19. The non-transitory computer-readable medium of claim 17, wherein the computer executable instructions that, when executed by a processor, further cause the processor determine a likelihood that the utterance includes a hotword.

20. The non-transitory computer-readable medium of claim 19, further comprising determining to transmit the utterance to the computing device based, at least in part, on the determining the likelihood that the utterance includes the hotword.
